(19) United States
(12) Patent Application Publication
(10) Pub. No.: US 2021/0248773 A1
(43) Pub. Date: Aug. 12, 2021

(54) POSITIONING METHOD AND APPARATUS, AND MOBILE DEVICE

(71) Applicant: Beijing Sankuai Online Technology Co., Ltd, Beijing (CN)

(72) Inventor: Yuda LIU, Beijing (CN)

(21) Appl. No.: 17/049,346

(22) PCT Filed: Dec. 13, 2018
(86) PCT No.: PCT/CN2018/120775

§ 371 Date: Oct. 21, 2020

(30) Foreign Application Priority Data
Jun. 21, 2018 (CN) 201810646527.X

(51) Int. Cl. G06T 7/70; G06T 7/20; G06T 7/00; G06K 9/62; G06N 3/08; G06N 3/04

(52) U.S. Cl. CPC G06T 7/70; G06T 7/20; G06T 7/97; G06T 2207/10016; G06N 3/08; G06N 3/0454; G06T 2207/20081; G06K 9/6256

(57) ABSTRACT

The present disclosure provides a positioning method and apparatus, and a mobile device. The method includes acquiring two adjacent frames of images of a target environment collected by a mobile device in the target environment, obtaining a first positioning result for the mobile device by inputting a last collected image of the two adjacent frames of images into a first deep learning model, determining a second positioning result for the mobile device based on the two adjacent frames and a previous comprehensive positioning result for the mobile device, and determining a comprehensive positioning result for the mobile device based on the first positioning result and the second positioning result.

### CROSS REFERENCE TO RELATED APPLICATIONS

The present application is the U.S. national phase of PCT Application No. PCT/CN2018/120775 filed on Dec. 13, 2018, which claims a priority of the Chinese patent application No. 201810646527.X filed on Jun. 21, 2018, which is incorporated herein by reference in its entirety.

### FIELD

The present disclosure relates to the field of information processing, and in particular, to a positioning method and apparatus, and a mobile device.

### BACKGROUND

With rapid development of the delivery industry, unmanned delivery has received increasing attention. Since mobile devices such as Unmanned Ground Vehicles (UGVs), Unmanned Aerial Vehicles (UAVs), or delivery robots may sense their surroundings and plan their driving paths, users can select appropriate mobile devices to deliver goods according to the actual environment, which can solve the difficulty in delivery of goods to environments such as remote mountainous areas and urban areas with traffic congestion.

### SUMMARY

In view of this, the present disclosure provides a positioning method and apparatus, and a mobile device.

According to a first aspect of the present disclosure, there is provided a positioning method including:
acquiring two adjacent frames of images of a target environment collected by a mobile device in the target environment;
obtaining a first positioning result for the mobile device by inputting a last collected image of the two adjacent frames of images into a first deep learning model;
determining a second positioning result for the mobile device based on the two adjacent frames of images and a previous comprehensive positioning result for the mobile device; and
determining a comprehensive positioning result for the mobile device based on the first positioning result and the second positioning result.

In an embodiment, the first deep learning model may be obtained by: acquiring multi-frame sample images of the target environment;
determining a positioning result for each frame of the sample images; and
training the first deep learning model by using the multi-frame sample images and the positioning result for each frame of the sample images as a training set.

In an embodiment, determining a second positioning result for the mobile device based on the two adjacent frames of images and a previous comprehensive positioning result for the mobile device may include:
obtaining a motion estimation result for the mobile device by inputting the two adjacent frames of images into a second deep learning model; and
determining the second positioning result for the mobile device based on the motion estimation result and the previous comprehensive positioning result for the mobile device.

In an embodiment, the second deep learning model may be obtained by:
acquiring continuous multi-frame sample images collected by the mobile device in the target environment;
determining a motion estimation result for every two adjacent frames of the continuous multi-frame sample images; and
training the second deep learning model by using the continuous multi-frame sample images and the motion estimation result for every two adjacent frames of the continuous multi-frame sample images as a training set.

In an embodiment, determining a comprehensive positioning result for the mobile device based on the first positioning result and the second positioning result may include:
obtaining the comprehensive positioning result for the mobile device by fusing the first positioning result and the second positioning result based on Kalman filtering.

In an embodiment, obtaining the comprehensive positioning result for the mobile device by fusing the first positioning result and the second positioning result based on Kalman filtering may include:
obtaining a final Gaussian distribution parameter for characterizing the comprehensive positioning result by multiplying a first Gaussian distribution parameter for characterizing the first positioning result and a second Gaussian distribution parameter for characterizing the second positioning result.

In an embodiment, the first positioning result may include first positioning information with six degrees of freedom, the second positioning result may include second positioning information with six degrees of freedom, and the comprehensive positioning result may include comprehensive positioning information with six degrees of freedom.

According to a second aspect of the present disclosure, there is provided a positioning apparatus including:
an adjacent image acquisition device, configured to acquire two adjacent frames of images of a target environment collected by a mobile device in the target environment;
a first result acquisition device, configured to obtain a first positioning result for the mobile device by inputting a last collected image of the two adjacent frames of images into a first deep learning model;
a second result determination device, configured to determine a second positioning result for the mobile device based on the two adjacent frames of images and a previous comprehensive positioning result for the mobile device; and
a comprehensive result determination device, configured to determine a comprehensive positioning result for the mobile device based on the first positioning result and the second positioning result.

According to a third aspect of the present disclosure, there is provided a mobile device including:
a processor; and
a memory configured to store processor-executable instructions;
and the processor is configured to perform any of the above positioning methods.

According to a fourth aspect of the present disclosure, there is provided a computer readable storage medium storing computer programs therein, the computer programs are configured to perform any of the above positioning methods.

As can be seen from the above, two adjacent frames of images of a target environment collected by a mobile device in the target environment are acquired, a first positioning result for the mobile device is obtained by inputting the last collected image of the two adjacent frames of images into a first deep learning model, and a second positioning result for the mobile device is determined based on the two adjacent frames of images and a previous comprehensive positioning result for the mobile device, and then a comprehensive positioning result for the mobile device is determined based on the first positioning result and the second positioning result, thus the positioning can be performed only relying on the model itself instead of a huge feature library, so that the feasibility of the positioning scheme can be improved and the accuracy of the positioning scheme can be improved.

### BRIEF DESCRIPTION OF DRAWINGS

FIG. 1 is a flowchart illustrating a positioning method according to an embodiment of the present disclosure.

FIG. 2 is a flowchart illustrating a positioning method according to another embodiment of the present disclosure.

FIG. 3 is a flowchart illustrating how to determine a second positioning result for a mobile device according to an embodiment of the present disclosure.

FIG. 4 is a flowchart illustrating how to determine a second positioning result for a mobile device according to another embodiment of the present disclosure.

FIG. 5 is a structural diagram illustrating a positioning apparatus according to an embodiment of the present disclosure.

FIG. 6 is a structural diagram illustrating a positioning apparatus according to another embodiment of the present disclosure.

FIG. 7 is a structural diagram illustrating a mobile device according to an embodiment of the present disclosure.

### DETAILED DESCRIPTION

Embodiments will be described in detail herein, with the illustrations thereof represented in the drawings. When the following descriptions involve the drawings, like numerals in different drawings refer to like or similar elements unless otherwise indicated. The following embodiments do not represent all embodiments consistent with the present disclosure. Rather, they are merely embodiments of apparatuses and methods consistent with some aspects of the present disclosure as detailed in the appended claims.

The terms used in the present disclosure are for the purpose of describing particular embodiments only, and are not intended to limit the present disclosure. Terms determined by “a”, “the” and “said” in their singular forms in the present disclosure and the appended claims are also intended to include plurality or multiple, unless clearly indicated otherwise in the context. It should also be understood that the term “and/or” as used herein is and includes any and all possible combinations of one or more of the associated listed items.

It is to be understood that, although terms “first”, “second”, “third” and the like may be used in the present disclosure to describe various information, such information should not be limited to these terms. These terms are only used to distinguish one category of information from another. For example, without departing from the scope of the present disclosure, first information may be referred to as second information; and similarly, second information may also be referred to as first information. Depending on the context, the word “if” as used herein may be interpreted as “when” or “upon” or “in response to determining”.

During autonomous driving, mobile devices are required to accurately position themselves in order to perform operations such as environment sensing and path planning. In the Visual Simultaneous Localization and Mapping (VSLAM), positioning is performed based on each frame of image, and feature points are extracted from each frame of image to form a feature point library. In this way, the wider the positioning range, the more data in the feature point library, which in turn leads to a lower feasibility and a lower positioning accuracy of performing positioning based on each frame of image.

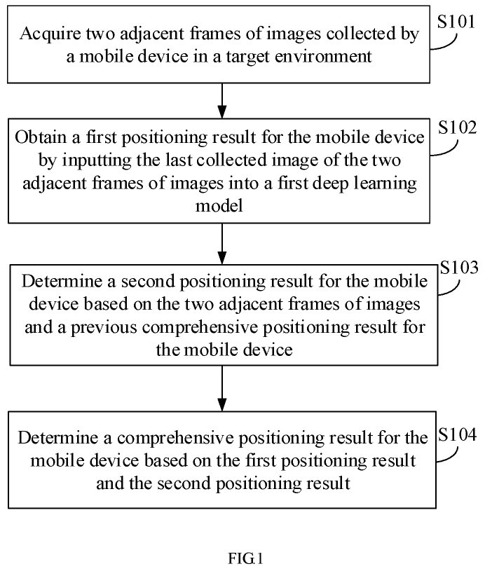

In order to improve the positioning accuracy, the present disclosure provides a positioning method. FIG. 1 is a flowchart illustrating a positioning method according to an embodiment of the present disclosure, which may be applied to a mobile device, and may also be applied to a server-side (such as one server and a server cluster including multiple servers). As shown in FIG. 1, the positioning method may include steps S101-S104.

At step S101, two adjacent frames of images in a target environment collected by a mobile device during driving are acquired.

In an embodiment, the mobile device may include but is not limited to a UGV, a UAV, or a delivery robot.

In an embodiment, the mobile device, when driving in the target environment, may collect video images in the target environment in real time through its own image capturing apparatus (such as a camera). Further, the image capturing apparatus may transmit two adjacent frames of the collected video image to the mobile device in a wired or wireless manner.

In an embodiment, if the last collected image of the two adjacent frames of images is the image currently collected by the image capturing apparatus, a comprehensive/integrated positioning result obtained in the following step S104 is the current positioning result for the mobile device.

At step S102, a first positioning result for the mobile device is obtained by inputting the last collected image of the two adjacent frames of images into a first deep learning model, where the first deep learning model is used for visual positioning.

In an embodiment, after the two adjacent frames of images are acquired, the last collected image of the two adjacent frames of images may be input into the first deep learning model for visual positioning to obtain the first positioning result for the mobile device.

In an embodiment, the first deep learning model may be a pre-trained neural network model for visual positioning, the input of which may include a single frame of image and the output may include the first positioning result for the mobile device.

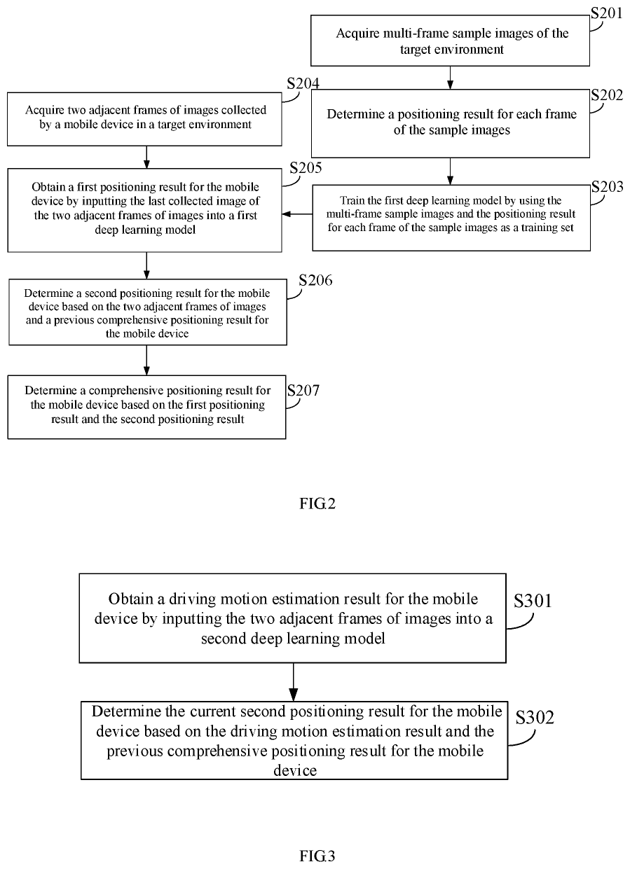

In an embodiment, a training method of the first deep learning model is illustrated in the embodiment shown in FIG. 2, which will not be described in detail herein.

In an embodiment, the first positioning result may include positioning information on position and attitude of the mobile device with a total of six degrees of freedom, that is, degrees of freedom of movement along directions of three rectangular coordinate axes x, y, and z and degrees of freedom of rotation around the three coordinate axes, as well as respective error of each degree of freedom. Similarly, a second positioning result and a comprehensive positioning result to be described later may also include positioning information with the six degrees of freedom and respective error of each degree of freedom.

At step S103, the second positioning result for the mobile device is determined based on the two adjacent frames of images and a previous comprehensive positioning result for the mobile device.

It should be noted that the steps S102 and S103 may be performed in parallel, rather than in sequence.

In an embodiment, while the step S102 is performed, a driving motion estimation result for the mobile device may be determined based on the two adjacent frames of images, and then combined with the previous comprehensive positioning result for the mobile device to obtain the second positioning result for the mobile device. For example, the previous comprehensive positioning result and the current driving motion estimation result may be summed to obtain the second positioning result.

In an embodiment, the previous comprehensive positioning result may be a comprehensive positioning result for the mobile device determined based on a previous frame of the currently collected image and the one before the previous frame.

In an embodiment, a method of determining the second positioning result for the mobile device is illustrated in the embodiment shown in FIG. 3, which will not be described in detail herein.

At step S104, the comprehensive positioning result for the mobile device is determined based on the first positioning result and the second positioning result.

In an embodiment, after the first positioning result is obtained based on the currently collected image and the second positioning result is obtained based on the two adjacent frames of images, the comprehensive positioning result for the mobile device may be determined based on the first positioning result and the second positioning result.

In an embodiment, the comprehensive positioning result for the mobile device may be obtained by fusing the first positioning result and the second positioning result based on Kalman filtering.

In an embodiment, each of the first positioning result and the second positioning result is essentially a distribution, which may be abstracted as a Gaussian distribution. Taking one degree of freedom as an example, if a positioning result includes “displacement: lm”, it can be determined that: the displacement is lm with a higher probability (for example, 60%); the displacement deviates by 10% with a small probability (for example, 30%), which is 0.9 m or 1.1 m; and the displacement deviates by 50% with a smaller probability (for example, 10%), etc. A mean of the Gaussian distribution may be determined as the displacement positioning result, and a variance of the Gaussian distribution may be determined as the error of the displacement positioning result.

Similarly, each driving motion estimation result may also be abstracted as a Gaussian distribution. Taking one degree of freedom as an example, if a driving motion estimation result includes “displacement change: +1 m”, it can be determined that: the displacement change is +1 m with a higher probability (for example, 60%); the displacement change deviates by 10% with a small probability (for example, 30%), which is +0.9 m or +1.1 m; and the displacement change deviates by 50% with a smaller probability (for example, 10%), etc. A mean of the Gaussian distribution may be determined as the displacement change result, and a variance of the Gaussian distribution may be determined as the error of the displacement change result.

In an embodiment, a first Gaussian distribution parameter for characterizing the first positioning result and a second Gaussian distribution parameter for characterizing the second positioning result may be multiplied to obtain a final Gaussian distribution parameter for characterizing the comprehensive positioning result. For example, the following equations (1) and (2) may be utilized to calculate the Gaussian distribution parameter for characterizing the comprehensive positioning result.

$$\begin{matrix}μ = \frac{{μ}_{1} {σ}_{1}^{2} + {μ}_{2} {σ}_{2}^{2}}{{σ}_{1}^{2} + {σ}_{2}^{2}} & ( 1 ) \\ \frac{1}{{σ}^{2}} = \frac{1}{{σ}_{1}^{2}} + \frac{1}{{σ}_{2}^{2}} & ( 2 )\end{matrix}$$

Where, μ₁ and σ₁ are the first Gaussian distribution parameters for characterizing the first positioning result, that is, the mean and variance of the first Gaussian distribution; μ₂ and σ₂ are the second Gaussian distribution parameters for characterizing the second positioning result, that is, the mean and variance of the second Gaussian distribution; and μ and σ are the final Gaussian distribution parameters for characterizing the comprehensive positioning result, that is, the mean and variance of the final Gaussian distribution.

In an embodiment, σ is smaller than σ₁ and σ₂, thus the error of the comprehensive positioning result can be reduced and the positioning accuracy can be improved.

As can be seen from the above, two adjacent frames of images in the target environment collected by the mobile device during driving are acquired, the first positioning result for the mobile device is obtained by inputting the last collected image of the two adjacent frames of images into the first deep learning model for visual positioning, and the second positioning result for the mobile device is determined based on the two adjacent frames of images and the previous comprehensive positioning result for the mobile device, and then the comprehensive positioning result for the mobile device is determined based on the first positioning result and the second positioning result. Since the positioning of the mobile device is performed based on the first deep learning model, the positioning can be performed only relying on the model itself instead of a huge feature library, so that the feasibility of the positioning scheme can be improved. Moreover, the second positioning result for the mobile device is obtained based on the two adjacent frames of images collected by the mobile device during driving, and then the comprehensive positioning result for the mobile device is determined based on the first positioning result and the second positioning result, which takes into account not only the positioning result for each frame of image, but also the changes in motion between the two adjacent frames of images, so that the accuracy of the positioning scheme can be improved.

In addition, this embodiment can be implemented only with an image capturing apparatus without relying on devices such as Inertial Measurement Unit (IMU) and Global Positioning System (GPS), and thus the system costs can be reduced.

FIG. 2 is a flowchart illustrating a positioning method according to another embodiment of the present disclosure, which may be applied to a mobile device, and may also be applied to a server-side (such as one server and a server cluster including multiple servers). As shown in FIG. 2, the positioning method may include steps S201-S207.

At step S201, multi-frame sample images of the target environment may be acquired.

In an embodiment, the multi-frame sample images may be acquired for different positions and directions in the target environment, in order to train the first deep learning model for visual positioning.

In an embodiment, the target environment may be selected by a developer according to the actual needs of delivery business, for example, a country, province, city, or town, etc. where the delivery business is located may be selected, which is not limited in this embodiment.

At step S202, a positioning result for each frame of the sample images may be determined.

In an embodiment, after the multi-frame sample images of the target environment are acquired, each frame of the sample images may be calibrated to determine the positioning result for each frame of the sample images. For example, the position and direction of each frame of the sample images may be determined.

In an embodiment, the positioning result with six degrees of freedom may be determined for each frame of the sample images, that is, degrees of freedom of movement along directions of three rectangular coordinate axes x, y, and z, and degrees of freedom of rotation around the three coordinate axes.

At step S203, the first deep learning model may be trained by using the multi-frame sample images and the positioning result for each frame of the sample images as a training set.

In an embodiment, after the multi-frame sample images and the positioning result for each frame of the sample images are obtained, the multi-frame sample images and the positioning result for each frame of the sample images may be used as the training set to train the first deep learning model.

In an embodiment, the first deep learning model may include a Convolutional Neural Network (CNN) model, or the developer may select other models for training according to actual business needs, which is not limited in this embodiment.

It should be noted that, though a lot of sample data is required during the training of the first deep learning model, the sample data is no longer required after the model is trained, and only the trained model is required to be retained. The model itself may remember the training information, and the size of the model is fixed, and may not become larger as the range to be positioned becomes wider. That is to say, there is no need to rely on a huge feature library for positioning, which can improve the feasibility of the positioning scheme.

At step S204, two adjacent frames of images in the target environment collected by the mobile device during driving are acquired.

At step S205, the first positioning result for the mobile device is obtained by inputting the last collected image of the two adjacent frames of images into the first deep learning model for visual positioning.

At step S206, the second positioning result for the mobile device is determined based on the two adjacent frames of images and the previous comprehensive positioning result for the mobile device.

At step S207, the comprehensive positioning result for the mobile device is determined based on the first positioning result and the second positioning result.

The relevant explanations and descriptions for the steps S204-S207 are provided in the above embodiment, which will not be repeated herein.

As can be seen from the above, multi-frame sample images of the target environment may be acquired, positioning result for each frame of the sample images may be determined, and then the multi-frame sample images and the positioning result for each frame of the sample images may be used as a training set to train the first deep learning model, so that the first positioning result for the mobile device may be subsequently determined based on the first deep learning model. Since the sample data is no longer required after the model is trained and only the trained model is required to be retained, and the size of the model may not become larger as the range to be positioned becomes wider, there is no need to rely on a huge feature library for positioning, which can improve the feasibility of the positioning scheme.

FIG. 3 is a flowchart illustrating how to determine the second positioning result for the mobile device according to an embodiment of the present disclosure. This embodiment, on the basis of the foregoing embodiments, takes how to determine the second positioning result for the mobile device as an example to illustrate. As shown in FIG. 3, determining the second positioning result for the mobile device based on the two adjacent frames of images and a previous comprehensive positioning result for the mobile device at the step S103 may include steps S301-S302.

At step S301, the driving motion estimation result for the mobile device may be obtained by inputting the two adjacent frames of images into a second deep learning model, where the second deep learning model is used for estimating the motion based on vision.

In an embodiment, the second deep learning model for estimating the motion based on vision may be pre-trained. The input of this model may include two adjacent frames of images collected by the mobile device during autonomous driving, and the output may include the driving motion estimation result for the mobile device.

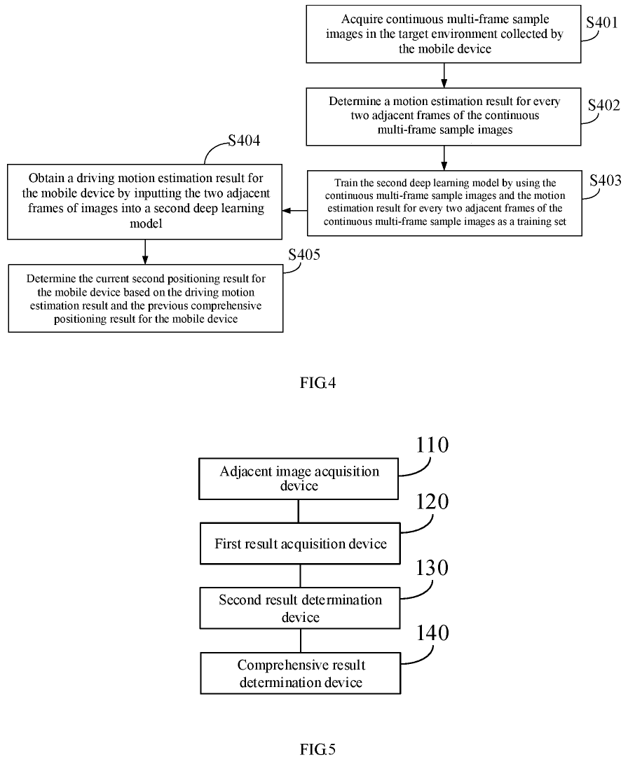

In an embodiment, a training process of the second deep learning model is illustrated in the embodiment shown in FIG. 4, which will not be described in detail herein.

In an embodiment, after two adjacent frames of images collected by the mobile device during autonomous driving are acquired, the two adjacent frames of images may be input into the second deep learning model to obtain the driving motion estimation result for the mobile device, where the second deep learning model is used for estimating the motion based on vision.

In an embodiment, the driving motion estimation result may be, for example, “displacement change: +2 m; direction change: +10°” (here still taking two degrees of freedom as an example, which may actually be extended consecutively to six degrees of freedom).

At step S302, the current second positioning result for the mobile device may be determined based on the driving motion estimation result and the previous comprehensive positioning result for the mobile device.

In an embodiment, the previous comprehensive positioning result may be a comprehensive positioning result for the mobile device determined based on the previous frame of the currently collected image and the one before the previous frame. For example, if the previous comprehensive positioning result determined based on the previous frame and the one before the previous frame is “displacement: 3 m; direction: 10°” (for illustrative purposes, here taking two degrees of freedom as an example, which may actually be extended consecutively to six degrees of freedom), the mobile device may calculate the driving motion estimation result for the currently collected image relative to the previous frame based on the currently collected image and the previous frame, which may be, for example, “displacement change: +2 m; direction change: +10°” (here still taking two degrees of freedom as an example, which may actually be extended consecutively to six degrees of freedom), and the previous comprehensive positioning result and the current driving motion estimation result may be summed to obtain the second positioning result of “displacement: 5 m; direction: 20°”.

As can be seen from the above, the driving motion estimation result for the mobile device may be obtained by inputting the two adjacent frames of images into the second deep learning model for estimating the motion based on vision, and the current second positioning result for the mobile device may be determined based on the driving motion estimation result and the previous comprehensive positioning result for the mobile device. The second positioning result for the mobile device is obtained based on the two adjacent frames of images collected by the mobile device during driving, and the comprehensive positioning result for the mobile device may be subsequently determined based on the first positioning result and the second positioning result, which takes into account not only the positioning result for each frame of image, but also the changes in motion between the two adjacent frames of images, so that the accuracy of the positioning scheme can be improved.

FIG. 4 is a flowchart illustrating how to determine the second positioning result for the mobile device according to another embodiment of the present disclosure. This embodiment, on the basis of the foregoing embodiments, takes how to determine the second positioning result for the mobile device as an example to illustrate. As shown in FIG. 4, determining the second positioning result for the mobile device based on the two adjacent frames of images and a previous comprehensive positioning result for the mobile device at the step S103 may include steps S401-S405.

At step S401, continuous multi-frame sample images in the target environment collected by the mobile device during driving may be acquired.

In an embodiment, in order to train the second deep learning model for estimating the motion based on vision, the continuous multi-frame sample images such as video images may be acquired when the mobile device is driving in different positions and directions in the target environment.

In an embodiment, the target environment may be selected by the developer according to the actual needs of delivery business, for example, a country, province, city, or town, etc. where the delivery business is located may be selected, which is not limited in this embodiment.

In an embodiment, the above mobile device may be the mobile device to be positioned in the embodiments of the present disclosure such as a UGV, a UAV, or a delivery robot. Since each mobile device has its own driving characteristics, the continuous multi-frame sample images in the target environment collected by the mobile device during driving may be utilized to train the second deep learning model, which can improve the pertinence of the model and ensure the accuracy of the motion estimation.

At step S402, a motion estimation result for every two adjacent frames of the continuous multi-frame sample images may be determined.

In an embodiment, after the continuous multi-frame sample images are acquired, every two adjacent frames of the continuous multi-frame sample images may be calibrated to determine the motion estimation result for every two adjacent frames of the continuous multi-frame sample images. For example, changes in position and direction between every two adjacent frames of the continuous multi-frame sample images may be determined.

In an embodiment, the motion estimation result with six degrees of freedom may be determined for every two adjacent frames of the sample images, that is, changes in degrees of freedom of movement along directions of three rectangular coordinate axes x, y, and z, and changes in degrees of freedom of rotation around the three coordinate axes.

At step S403, the second deep learning model may be trained by using the continuous multi-frame sample images and the motion estimation result for every two adjacent frames of the continuous multi-frame sample images as a training set.

In an embodiment, after the continuous multi-frame sample images and the motion estimation result for every two adjacent frames of the continuous multi-frame sample images are obtained, the continuous multi-frame sample images and the motion estimation result for every two adjacent frames of the continuous multi-frame sample images may be used as the training set to train the second deep learning model.

In an embodiment, the second deep learning model may include a Convolutional Neural Network (CNN) model, or the developer may select other models for training according to actual business needs, which is not limited in this embodiment.

It should be noted that, though a lot of sample data is required during the training of the second deep learning model, the sample data is no longer required after the model is trained, and only the trained model is required to be retained. The model itself may remember the training information, and the size of the model is fixed, and may not become larger as the range of the environment becomes wider. That is to say, there is no need to rely on a huge feature library for motion estimation, which can improve the feasibility of the motion estimation scheme.

At step S404, the driving motion estimation result for the mobile device may be obtained by inputting the two adjacent frames of images into the second deep learning model, where the second deep learning model is used for estimating the motion based on vision.

At step S405, the current second positioning result for the mobile device may be determined based on the driving motion estimation result and the previous comprehensive positioning result for the mobile device.

The relevant explanations and descriptions for the steps S404-S405 are provided in the above embodiment, which will not be repeated herein.

As can be seen from the above, continuous multi-frame sample images in the target environment collected by the mobile device during driving may be acquired, and motion estimation result for every two adjacent frames of the continuous multi-frame sample images may be determined, and then the continuous multi-frame sample images and the motion estimation result for every two adjacent frames of the continuous multi-frame sample images may be used as the training set to train the second deep learning model, so that the driving motion estimation result for the mobile device may be subsequently determined based on the second deep learning model. Since the sample data is no longer required after the model is trained and only the trained model is required to be retained, and the size of the model may not become larger as the range of the environment becomes wider, there is no need to rely on a huge feature library for motion estimation, which can improve the feasibility of the motion estimation scheme.

The present disclosure further provides apparatus embodiments corresponding to the foregoing method embodiments.

FIG. 5 is a structural diagram illustrating a positioning apparatus according to an embodiment of the present disclosure. As shown in FIG. 5, the positioning apparatus may include:
an adjacent image acquisition device 110, configured to acquire two adjacent frames of images in a target environment collected by a mobile device during driving;
a first result acquisition device 120, configured to obtain a first positioning result for the mobile device by inputting the last collected image of the two adjacent frames of images into a first deep learning model, where the first deep learning model is used for visual positioning;
a second result determination device 130, configured to determine a second positioning result for the mobile device based on the two adjacent frames of images and a previous comprehensive positioning result for the mobile device; and
a comprehensive result determination device 140, configured to determine a comprehensive positioning result for the mobile device based on the first positioning result and the second positioning result.

As can be seen from the above, two adjacent frames of images in the target environment collected by the mobile device during driving are acquired, the first positioning result for the mobile device is obtained by inputting the last collected image of the two adjacent frames of images into the first deep learning model for visual positioning, and the second positioning result for the mobile device is determined based on the two adjacent frames of images and the previous comprehensive positioning result for the mobile device, and then the comprehensive positioning result for the mobile device is determined based on the first positioning result and the second positioning result. Since the positioning of the mobile device is performed based on the first deep learning model, the positioning can be performed only relying on the model itself instead of a huge feature library, so that the feasibility of the positioning scheme can be improved. Moreover, the second positioning result for the mobile device is obtained based on the two adjacent frames of images collected by the mobile device during driving, and then the comprehensive positioning result for the mobile device is determined based on the first positioning result and the second positioning result, which takes into account not only the positioning result for each frame of image, but also the changes in motion between the two adjacent frames of images, so that the accuracy of the positioning scheme can be improved. In addition, this embodiment can be implemented only with an image capturing apparatus without relying on devices such as IMU and GPS, and thus the system costs can be reduced.

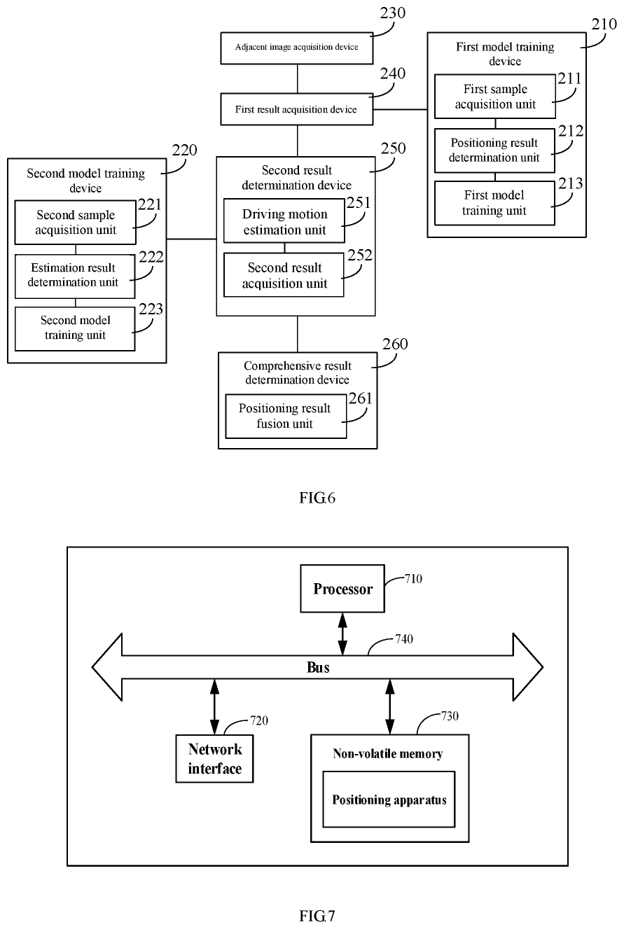

FIG. 6 is a structural diagram illustrating a positioning apparatus according to another embodiment of the present disclosure. An adjacent image acquisition device 230, a first result acquisition device 240, a second result determination device 250, and a comprehensive result determination device 260 in FIG. 6 have the same functions as those of the adjacent image acquisition device 110, the first result acquisition device 120, the second result determination device 130, and the comprehensive result determination device 140 in FIG. 5 respectively, which will not be repeated herein. As shown in FIG. 6, the positioning apparatus may further include a first model training device 210 configured to train a first deep learning model for visual positioning.

The first model training device 210 may include:
a first sample acquisition unit 211, configured to acquire multi-frame sample images of the target environment;
a positioning result determination unit 212, configured to determine a positioning result for each frame of the sample images; and
a first model training unit 213, configured to train the first deep learning model by using the multi-frame sample images and the positioning result for each frame of the sample images as a training set.

In an embodiment, the second result determination device 250 may include:
a driving motion estimation unit 251, configured to obtain a driving motion estimation result for the mobile device by inputting the two adjacent frames of images into a second deep learning model, where the second deep learning model is used for estimating the motion based on vision; and
a second result acquisition unit 252, configured to determine the second positioning result for the mobile device based on the driving motion estimation result and the previous comprehensive positioning result for the mobile device.

In an embodiment, the positioning apparatus may further include a second model training device 220 configured to train the second deep learning model for estimating the motion based on vision and including:
a second sample acquisition unit 221, configured to acquire continuous multi-frame sample images in the target environment collected by the mobile device during driving;
an estimation result determination unit 222, configured to determine a motion estimation result for every two adjacent frames of the continuous multi-frame sample images; and
a second model training unit 223, configured to train the second deep learning model by using the continuous multi-frame sample images and the motion estimation result for every two adjacent frames of the continuous multi-frame sample images as a training set.

In an embodiment, the comprehensive result determination device 260 may further include a positioning result fusion unit 261 configured to obtain the comprehensive positioning result for the mobile device by fusing the first positioning result and the second positioning result based on Kalman filtering.

In an embodiment, the positioning result fusion unit 261 may be further configured to obtain a final Gaussian distribution parameter for characterizing the comprehensive positioning result by multiplying a first Gaussian distribution parameter for characterizing the first positioning result and a second Gaussian distribution parameter for characterizing the second positioning result.

In an embodiment, the first positioning result may include first positioning information with six degrees of freedom, the second positioning result may include second positioning information with the six degrees of freedom, and the comprehensive positioning result may include comprehensive positioning information with the six degrees of freedom.

It should be noted that all of the embodiments described above may be combined in any way to form other embodiments of the present disclosure, which will not be repeated herein.

The embodiments of the positioning apparatus in the present disclosure can be applied to network devices. The apparatus embodiments can be implemented by software, hardware or a combination of software and hardware. Taking implementation by software as an example, the software, as a logical apparatus, is built by executing relevant computer program instructions that are read from a non-volatile memory into a memory through a processor of the device where it is located, where the computer program instructions, when read, cause the processor to perform the positioning method according to the embodiments shown in FIGS. 1-4. From a hardware perspective, as shown in FIG. 7 which is a hardware structure diagram illustrating the mobile device of the present disclosure, the device may include a processor 710, a network interface 720, a non-volatile memory 730, and a bus 740, in addition to other hardware such as a memory. In terms of hardware structure, the device may also be a distributed device, which may include interface cards. On the other hand, the present disclosure further provides a computer readable storage medium storing computer programs therein, the computer programs may be executed by the processor in the mobile device to perform the positioning method according to the embodiments shown in FIGS. 1-4.

For the apparatus embodiment, since it basically corresponds to the method embodiment, reference may be made to the partial description of the method embodiment. The apparatus embodiments described above are merely illustrative, and the units described as separate components may or may not be physically separate, and the components displayed as units may or may not be physical units, that is, may be located at one place, or may be distributed to multiple network units. Some or all of the devices may be selected according to actual needs to achieve the embodiments of the present disclosure.

It should also be noted that the terms “include”, “comprise” or any other variants thereof are intended to cover non-exclusive inclusion, so that a process, method, product, or device including a series of elements not only includes these elements, but also includes other elements that are not explicitly listed, or elements inherent to the process, method, product, or device. Without more restrictions, the element defined by the sentence “include a . . . ” does not exclude the existence of other identical elements in the process, method, product, or device that includes the element.

1. A positioning method, the method comprising:
acquiring two adjacent frames of images of a target environment collected by a mobile device in the target environment;
obtaining a first positioning result for the mobile device by inputting a last collected image of the two adjacent frames of images into a first deep learning model;
determining a second positioning result for the mobile device based on the two adjacent frames of images and a previous comprehensive positioning result for the mobile device; and
determining a comprehensive positioning result for the mobile device based on the first positioning result and the second positioning result.

2. The method of claim 1, wherein the first deep learning model is obtained by:
acquiring multi-frame sample images of the target environment;
determining a positioning result for each frame of the sample images; and
training the first deep learning model by using the multi-frame sample images and the positioning result for each frame of the sample images as a training set.

3. The method of claim 1, wherein determining a second positioning result for the mobile device based on the two adjacent frames of images and a previous comprehensive positioning result for the mobile device comprises:
obtaining a motion estimation result for the mobile device by inputting the two adjacent frames of images into a second deep learning model; and
determining the second positioning result for the mobile device based on the motion estimation result and the previous comprehensive positioning result for the mobile device.

4. The method of claim 3, wherein the second deep learning model is obtained by:
acquiring continuous multi-frame sample images collected by the mobile device in the target environment;
determining a motion estimation result for every two adjacent frames of the continuous multi-frame sample images; and
training the second deep learning model by using the continuous multi-frame sample images and the motion estimation result for every two adjacent frames of the continuous multi-frame sample images as a training set.

5. The method of claim 1, wherein determining a comprehensive positioning result for the mobile device based on the first positioning result and the second positioning result comprises:
obtaining the comprehensive positioning result for the mobile device by fusing the first positioning result and the second positioning result based on Kalman filtering.

6. The method of claim 5, wherein obtaining the comprehensive positioning result for the mobile device by fusing the first positioning result and the second positioning result based on Kalman filtering comprises:
obtaining a final Gaussian distribution parameter for characterizing the comprehensive positioning result by multiplying a first Gaussian distribution parameter for characterizing the first positioning result and a second Gaussian distribution parameter for characterizing the second positioning result.

7. The method of claim 1, wherein:
the first positioning result comprises first positioning information with six degrees of freedom,
the second positioning result comprises second positioning information with six degrees of freedom, and
the comprehensive positioning result comprises comprehensive positioning information with six degrees of freedom.

8-13. (canceled)

14. A mobile device, comprising:
a processor; and
a memory configured to store processor-executable instructions;
wherein the processor is configured to:
acquire two adjacent frames of images of a target environment collected by a mobile device in the target environment;
obtain a first positioning result for the mobile device by inputting a last collected image of the two adjacent frames of images into a first deep learning model;
determine a second positioning result for the mobile device based on the two adjacent frames of images and a previous comprehensive positioning result for the mobile device; and
determine a comprehensive positioning result for the mobile device based on the first positioning result and the second positioning result.

15. The mobile device of claim 14, wherein obtaining of the first deep learning model further comprises:
acquiring multi-frame sample images of the target environment;
determining a positioning result for each frame of the sample images; and
training the first deep learning model by using the multi-frame sample images and the positioning result for each frame of the sample images as a training set.

16. The mobile device of claim 14, wherein when determining a second positioning result for the mobile device based on the two adjacent frames of images and a previous comprehensive positioning result for the mobile device, the processor is further configured to:
obtain a motion estimation result for the mobile device by inputting the two adjacent frames of images into a second deep learning model; and
determine the second positioning result for the mobile device based on the motion estimation result and the previous comprehensive positioning result for the mobile device.

17. The mobile device of claim 16, wherein obtaining of the second deep learning model further comprises:
acquiring continuous multi-frame sample images collected by the mobile device in the target environment;
determining a motion estimation result for every two adjacent frames of the continuous multi-frame sample images; and
training the second deep learning model by using the continuous multi-frame sample images and the motion estimation result for every two adjacent frames of the continuous multi-frame sample images as a training set.

18. The mobile device of claim 14, wherein when determining a comprehensive positioning result for the mobile device based on the first positioning result and the second positioning result, the processor is further configured to:
obtain the comprehensive positioning result for the mobile device by fusing the first positioning result and the second positioning result based on Kalman filtering.

19. The mobile device of claim 18, wherein when obtaining the comprehensive positioning result for the mobile device by fusing the first positioning result and the second positioning result based on Kalman filtering, the processor is further configured to:
obtain a final Gaussian distribution parameter for characterizing the comprehensive positioning result by multiplying a first Gaussian distribution parameter for characterizing the first positioning result and a second Gaussian distribution parameter for characterizing the second positioning result.

20. The mobile device of claim 14, wherein:
the first positioning result comprises first positioning information with six degrees of freedom,
the second positioning result comprises second positioning information with six degrees of freedom, and
the comprehensive positioning result comprises comprehensive positioning information with six degrees of freedom.

21. A computer readable storage medium including computer programs therein, wherein, the computer programs, when executed by a processor in a mobile device, cause the processor to:
acquire two adjacent frames of images of a target environment collected by a mobile device in the target environment
obtain a first positioning result for the mobile device by inputting a last collected image of the two adjacent frames of images into a first deep learning model;
determine a second positioning result for the mobile device based on the two adjacent frames of images and a previous comprehensive positioning result for the mobile device; and
determine a comprehensive positioning result for the mobile device based on the first positioning result and the second positioning result.

22. The computer readable storage medium of claim 21, wherein obtaining of the first deep learning model further comprises:
acquiring multi-frame sample images of the target environment;
determining a positioning result for each frame of the sample images; and
training the first deep learning model by using the multi-frame sample images and the positioning result for each frame of the sample images as a training set.

23. The computer readable storage medium of claim 21, wherein when determining a second positioning result for the mobile device based on the two adjacent frames of images and a previous comprehensive positioning result for the mobile device, the computer programs further cause the processor to:
obtain a motion estimation result for the mobile device by inputting the two adjacent frames of images into a second deep learning model; and
determine the second positioning result for the mobile device based on the motion estimation result and the previous comprehensive positioning result for the mobile device.

24. The computer readable storage medium of claim 23, wherein obtaining of the second deep learning model further comprises:
acquiring continuous multi-frame sample images collected by the mobile device in the target environment;
determining a motion estimation result for every two adjacent frames of the continuous multi-frame sample images; and
training the second deep learning model by using the continuous multi-frame sample images and the motion estimation result for every two adjacent frames of the continuous multi-frame sample images as a training set.

25. The computer readable storage medium of claim 21, wherein when determining a comprehensive positioning result for the mobile device based on the first positioning result and the second positioning result, the computer programs further cause the processor to:
obtain the comprehensive positioning result for the mobile device by fusing the first positioning result and the second positioning result based on Kalman filtering.

26. The computer readable storage medium of claim 25, wherein when obtaining the comprehensive positioning result for the mobile device by fusing the first positioning result and the second positioning result based on Kalman filtering, the computer programs further cause the processor to:
obtain a final Gaussian distribution parameter for characterizing the comprehensive positioning result by multiplying a first Gaussian distribution parameter for characterizing the first positioning result and a second Gaussian distribution parameter for characterizing the second positioning result.
